(19) United States
(12) Patent Application Publication
(10) Pub. No.: US 2009/0138971 A1
(43) Pub. Date: May 28, 2009

(54) Detecting Intrusion by Rerouting of Data Packets in a Telecommunications Network

(75) Inventor: Laurent Butti, Issy Les Moulineaux (FR)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 11/988,558

(22) PCT Filed: Jun. 28, 2006
(86) PCT No.: PCT/FR2006/001508

§ 371 Date: Jan. 10, 2008

(30) Foreign Application Priority Data
Jul. 13, 2005 (FR) 0507532

(51) Int. Cl. G06F 21/00

(52) U.S. Cl. 726/23

(57) ABSTRACT

The invention proposes detection of man-in-the-middle intrusion between an entity (CL) and an access point (AP) of a network, in particular a network according to the IEEE-802.11 standard. To this end it proposes the following steps: a) reading frame bodies (FRA-i, . . . , FRA-i+3) transmitted between the entity and the access point, b) detecting frames (FRA-i, FRA-i+2) transmitted at respective different times but having identical frame bodies (fb), and c) triggering an alarm in the event of positive detection in the step b).

The present invention relates generally to detecting intrusion between an access point of a network and an entity communicating via that network.

Piracy techniques have been encountered in wireless networks, specified in the [IEEE802.11-1997] and [IEEE802.11-1999] standards, among others, that are in widespread use in business and domestic networks known as “hot-spots”, and one of the greatest risks to such networks is the creation of a false access point in order to intercept calls of legitimate entities known as “clients” and thus recover private (or “payload”) data. This category of attack is called an “illegitimate access point attack”.

The access point is in fact crucial to communication between a client and a network. In a known attack using a false access point, the attacker becomes insinuated between a legitimate client and a legitimate network access point. In this position, the attacker is then able to intercept all calls. These attacks are called man-in-the-middle attacks.

In the context of the present invention, communication is effected by means of packets of data generally including a field in which at least the source address and the destination address of the packets can be identified. These are typically MAC (Medium Access Control) or IP (Internet Protocol) addresses.

As a general rule, man-in-the-middle attacks are difficult to detect because the techniques they can use include MAC address misappropriation. It then becomes difficult to distinguish between two different pieces of equipment sending from the same MAC address.

This type of attack is particularly effective and beneficial for the attacker when the legitimate connection, in a wireless network, for example, is not encrypted and is in an “infrastructure” mode, i.e. between a client and an access point. This is typical of the hot-spot technology deployed by mobile telephone operators and most corporate wireless access networks (even though they use higher level (above level 2) security mechanisms such as IPsec, SSH (Secure SHell) or TLS (Transport Layer Security) for access by employees).

The present invention is aimed in particular at effective detection of a man-in-the-middle attack for hot-spot or corporate networks. With corporate networks, the effectiveness of the attack depends greatly on the security mechanisms used by the organization, and in particular their vulnerability to active attacks.

A man-in-the-middle (MITM) attack is described in detail below.

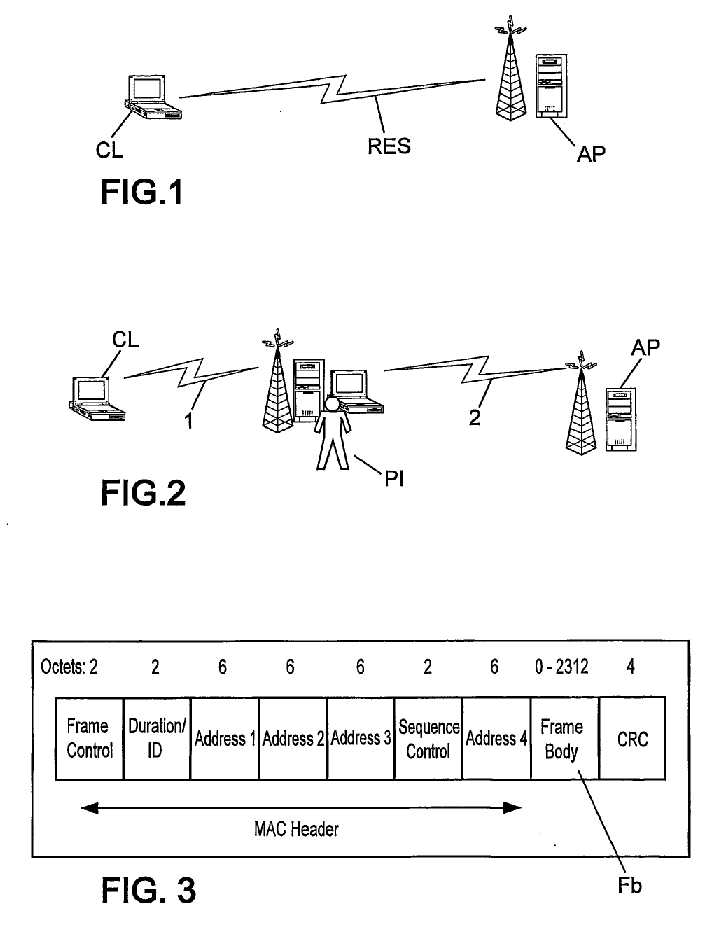

Referring to the general FIGS. 1 and 2, during a conventional call in infrastructure mode, a client CL is directly connected to an access point AP via a telecommunications network RES. In a standard connection as represented in FIG. 1, the client then accesses services offered by a second network that is situated beyond the access point(s), for example Internet access when using a WiFi hot-spot.

Unfortunately, the legitimate client CL has little information about the legitimate access point to which the client is connected. In practice, this information is often the network name (Extended Service Set Identifier (ESSID)), or the MAC address (Basic Service Set Identifier (BSSID)). However, these elements can usually be misappropriated easily.

In numerous environments, a pirate is generally able to carry out an MITM attack by misappropriating the access point function for the client and the client function for the access point. Referring to FIG. 2 illustrating an MITM attack, the pirate PI sets up as a “transparent” relay and therefore intercepts all packets sent by the client and by the legitimate access point.

To emulate a false access point, the attacker chooses a network name (ESSID), a wireless interface MAC address (BSSID), and a radio channel on which to send. Where appropriate, these three elements can be chosen to be the same as those of the legitimate access point, to minimize the chances of the attacker being easily detected because, in fact, appropriate intrusion detection tools could easily identify a change, such as the appearance of a new access point with characteristics other than those of the legitimate access points. However, for reasons of interference, and therefore of the effectiveness of the attack, the attacker must generally choose a channel different from that of the legitimate access point.

The present invention is not limited to one of these particular examples relating to attack variants. It is consequently clear that these variants are not described in detail.

Moreover, for the attack to proceed without being easily detected by the client, the pirate retransmits all information received between the legitimate client and the legitimate access point. Referring to FIG. 2, the pirate PI relays via the arrow 2 data received via the arrow 1, and vice-versa.

At present, no single reliable technique for detecting MITM attacks has been proposed. Multiple techniques for detecting the various stages of the attack are generally used conjointly. Then, by correlating the various results obtained (typically using a mechanism for detecting a sequence of events), the attack as such is identified.

The following techniques can be used simultaneously: - detecting de-association (or de-authentication) of a client in order to disconnect a legitimate client from the legitimate access point with which it is associated;
detecting one or more misappropriations of MAC addresses depending on whether the attacker misappropriates only the MAC address of the access point or also that of the client, for example by analyzing the sequence number identifiers;
detecting creation of an illegitimate access point (for example with the same BSSID and the same ESSID as a legitimate access point but a different radio channel); and
where applicable, detecting a number of Extensible Authentication Protocol (EAP) messages greater than the number normally used by a client to connect to an access point. In this type of attack, the legitimate client is associated with the illegitimate access point and the attacker misappropriates the identity of the legitimate client to be associated with the legitimate access point. It is therefore clear that twice as many EAP frames are broadcast with the same source and destination MAC addresses. The MAC address criterion can vary depending on whether the attacker also misappropriates the MAC address of the legitimate client or only that of the legitimate access point.

Thus an attack is usually detected with the aid of a logical succession of events. However, those events can each be the subject of false positives (false alarms) but also and more importantly false negatives (undetected attacks) if the decision is taken to detect the attack only if all the aforementioned conditions are met.

The technique based on analyzing the sequence number requires the management of very precise thresholds that are difficult to position. Consequently, this technique alone is difficult to use to ensure the absence of false positives and false negatives. The main difficulty is managing packet losses in long-distance transmission, for example. Some packets will inevitably be lost, which will lead to false positives because the sequence numbers will vary significantly from one packet to another. It is therefore necessary to manage the thresholds in a highly refined manner.

Techniques for identifying de-association of a client and analyzing the number of EAP frames used at the time of client reconnection are also subject to the risk of loss of packets. In fact, de-authentication of a client relies on only one packet (de-association or de-authentication frame) which, for example in the event of overloading the calculation capacities of a probe, may not be seen by that probe. Similarly, the method of enumerating the EAP packets does not tolerate the loss of packets.

Furthermore, the MITM attack can also proceed at the time the client joins the network. The new client is then connected to a false access point that was awaiting its arrival, and that false access point can then carry out the second portion of the attack, misappropriating the information of the client in order to connect to the legitimate access point. No de-association or de-authentication frame is then exchanged, making detection of the attack even more unlikely.

The present invention aims to improve on the situation.

To this end it proposes a method of detecting intrusion into communication of private data between a first entity and second entity communicating via a telecommunications network;
communication being effected by sending successive packets, each packet including at least:
   a header field including at least a source address of the packet and/or a destination address of the packet for appropriate routing of the packets; and
   a packet body including private data;
said intrusion consisting at least in:
   connecting between the first entity and the second entity;
   misappropriating the address of the first entity and/or the address of the second entity as source address and/or destination address; and
   rerouting packets in this way to recover in particular the private data;
      which method includes the steps of:
a) detecting at least a first packet and a second packet having identical packet bodies and transmitted at respective different times between the first entity and the second entity; and
b) triggering an alarm if the number of packets with identical bodies detected in the step a) is greater than a predetermined threshold.

The present invention finds an advantageous application in its use in a wireless telecommunications network, advantageously one configured in accordance with the IEEE 802.11 standard, which can be connected to an extended network, in particular in a hot-spot context, for detecting man-in-the-middle intrusion. The aforementioned second entity can then be an access point of the wireless network.

Besides, other features and advantages of the invention become apparent on reading the following detailed description and examining the appended drawings, in which:

FIG. 1, described above, is a diagram illustrating one example of a situation of a normal call between a client entity and an access point of a telecommunications network;

FIG. 2 is a diagram illustrating the situation of a man-in-the-middle attack in the context of FIG. 1;

FIG. 3 represents by way of example the structure of a data packet or frame transmitted in accordance with the IEEE 802.11 standard;

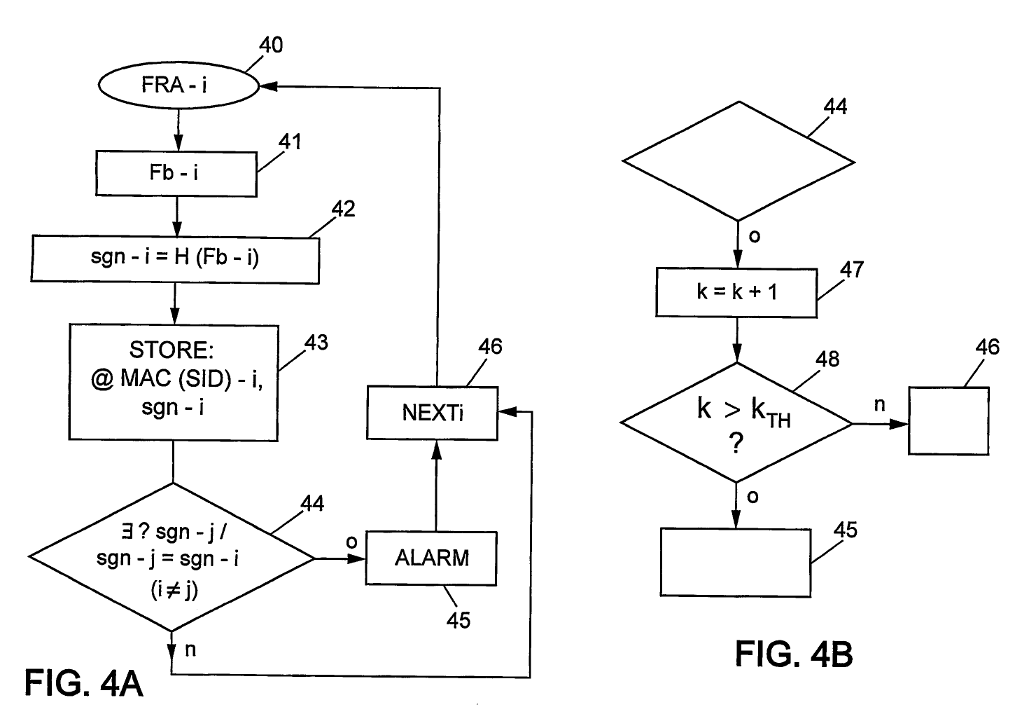

FIG. 4A illustrates the main steps of the method of the invention, in a first embodiment, corresponding to a flowchart of a computer program in said first embodiment;

FIG. 4B illustrates some of the steps of a variant of a method from FIG. 4A, in a second embodiment, corresponding to a flowchart of a computer program in said second embodiment; and

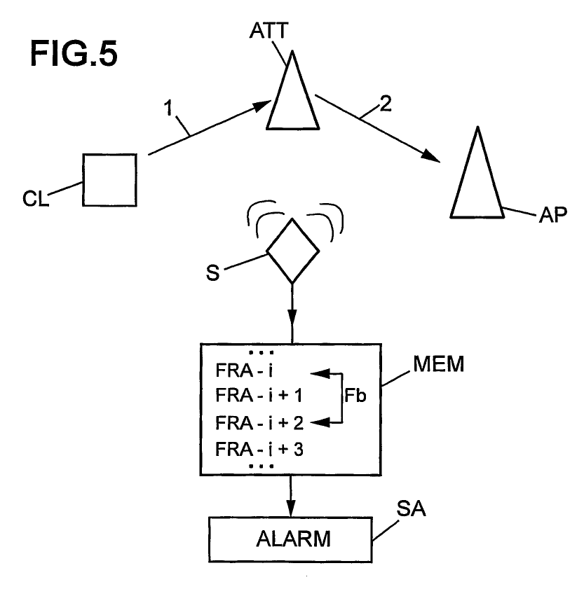

FIG. 5 illustrates the operation of a probe, for example a probe of a network control system, for implementing the present invention.

In the embodiments explained in the following detailed description, there is considered a wireless network according to the IEEE 802.11 standard operating in an infrastructure mode (between a client and an access point) and without encrypting data at the radio level. Detection, in accordance with the invention, of man-in-the-middle attacks between an access point considered as legitimate and the client is described in this context. The invention is adapted especially to the context of hot-spots.

To effect this detection, it is advantageous to provide an infrastructure for listening to the radio channel. Legitimate clients and legitimate access points cannot detect attacks and in particular cannot identify MITM attacks. The listening infrastructure can be deployed in addition to an existing IEEE 802.11 architecture.

In this context, the invention utilizes the following principle.

It is assumed that, in an IEEE 802.11 wireless local area network including a legitimate access point and a legitimate client, an attacker is carrying out a man-in-the-middle attack between the legitimate client and the legitimate access point and is therefore retransmitting packets received from the client to the legitimate access point.

When the legitimate client sends an IEEE 802.11 data packet, that packet is made up of an IEEE 802.11 header and a “data” part. The header contains information relating to the IEEE 802.11 network enabling correct routing of the packet from the source to the destination. When the attacker retransmits this packet to the legitimate access point, a certain number of fields of this header have been modified (it might even be said that the header has been totally recreated by the attacker). In contrast, the data part of the packet does not change. This data part contains headers of the higher network layers (for example IP, TCP, UDP, ICMP) and data of the application layers.

The invention is therefore based on the following principle. It is possible for a probe to capture and then to analyze variations of these data fields of the packets. When two data fields have been identified as identical in different packets within a relatively short time interval, it can be assumed that a man-in-the-middle attack is in progress.

The probe advantageously listens to the radio link on different channels. Thus, in more general terms, the network includes a plurality of communications channels and the steps of the detection method are carried out for at least two of those channels, and preferably for each of the channels.

The content of a data packet or frame according to the IEEE 802.11 standard is described below with reference to FIG. 3.

The frame includes firstly a MAC header field that is defined by the aforementioned IEEE 802.11 standard. It also includes a CRC field associated with an error detector code.

The content of the private data transported is included in a subsequent packet body or frame body fb. This frame body field also contains the payload data of calls (in particular TCP/IP). The application content of the frame body can generally be of the form:
Link layer, for example LLC (Logical Link Control);
Network layer, generally IP (Internet Protocol);
Transport layer, generally TCP (Transport Control Protocol) or UDP (User Datagram Protocol);
then a particular application protocol, encapsulated in the transport protocol.

The aim is to eavesdrop on the radio channel carrying IEEE 802.11 frames in transit thereon. In particular, the content of the data frames (in fact all or part of the frame body) is compared each time with the content of data frames previously received to detect duplicate frames received (duplicate in terms of their frame body). If such frames are regularly identified on the radio channel, then a man-in-the-middle attack is in progress.

A principle of the present invention is that packets of protocols of layers above the MAC layer (in particular in the OSI model) are generally subject to important variations. In fact, these protocols for the most part use mechanisms for identifying packets sent, for example an identifier coded on two bytes eight-bit for IP, a sequence number coded on two bytes for ICMP (Internet Control Message Protocol), a sequence number and an acknowledgement number coded on four bytes for TCP. Thus in practice packets, in particular frame bodies, are generally never the same, even if they correspond to the retransmission of a frame (a field is changed to specify retransmission or a sequence number is changed). Consequently, the invention is particularly adapted to effecting an efficient analysis with a very low number of false positives and false negatives.

In more general terms, it should be remembered that packets can be sent in accordance with a communications protocol that uses data included in the packet bodies to identify the packets sent, which makes detection of MITM intrusion certain if the bodies of the packets are identical.

Furthermore, a particular “repeater” mode of the 802.11 standard aims to use an 802.11 access point to retransmit received frames identically. This mode is very little used in practice. Its use would be detected as an attack by the invention. However, a simple “whitelist” would readily solve the problem.

The present invention is also directed to a probe for implementing the above method defined below in generic terms. It can advantageously be an intrusion detection probe adapted to wireless networks and located on a geographical site to be monitored. The probe is capable of raising alarms as a function of certain identified events. A particular analysis of the content of frames (or even sequences of frames) sent constitutes a signature that an intrusion detection tool can identify. That signature characterizes an event, such as an attack or simply a normal behavior.

The probe preferably has specific capacities that enable it to “listen” to more than one channel at a time, preferably ensuring that no or few data frames are lost while listening.

Two possible embodiments of the invention are described below.

A first embodiment includes the steps illustrated in FIG. 4A that represent one example of a flowchart of a computer program for implementing the invention.

Successive data packets FRA-i are recovered (step 40) by listening to a network, typically one conforming to the IEEE 802.11 standard, using a probe of the above type. A received packet FRA-i is then analyzed, in particular to recover its frame body fb-i (step 41), which includes private data that a client entity wishes to send to an access point, for example. The step 42 calculates a signature sgn-i by applying a hashing function H to all or part of the frame body fb-i. The result can take the form of a number on 128 bits (using the Message Digest 5 (MD5) function) or 160 bits (using the Secure Hash Algorithm 1 (SHA1) function), for example, or on n bits (using some other hashing function). This value, denoted sgn-i in FIG. 4A, is referred to as HASH_FRAMEBODY below. The frame body portion hashed to calculate the signature can be an element that is important for reasons of performance. In fact, the invention can be optimized so as to perform a hashing calculation on only the first 100 bytes, for example. It can then amount to setting parameters of the probe implementing the invention. This point can also be important with certain categories of attacks that can lead to modification of certain fixed bytes of the frame body fb-i. It is then possible to define bytes that are not to be verified so that certain classes of attacks can be detected. This point can also consist in setting parameters of the tool implementing the invention.

Accordingly, in more general terms, for each packet received:
a signature of the body of the packet is calculated by applying a hashing function to all or part of the data of the packet body;
said signature of stored in memory; and
said signature is compared to packet body signatures previously stored in said memory.

The hashing function is preferably applied to a portion of the data of the packet body chosen as a function of the configuration of the network and/or as a function of the pertinence of that data to intrusion detection.

In the step 43, the address information (for the most part in the packet header), for example at least of @MAC_source type (source MAC address), @MAC_destination type (destination MAC address), and advantageously @MAC_BSSID type, as well as, where applicable, a flag TO_DS/FROM_DS (named STATE_DS) are put into archive storage at the same time as the signature of the frame body. The aforementioned flag TO_DS is a field indicating that the packet coming from the client is intended for the network beyond the access point (typically a cable network). The flag FROM_DS is a field indicating that the frame coming from the access point is from an equipment situated beyond the access point (in the cable network). These identifiers are commonly used in a Wi-Fi context, as emerges with reference to a third embodiment described below.

@MAC_source, @MAC_destination, @MAC_BSSID, STATE_DS, HASH_FRAMEBODY are advantageously stored in a FIFO (first in first out) memory, as a quintuplet, preferably for a predefined period, the oldest quintuplets being automatically deleted and replaced on reaching their end of life. Their lifetime can in practice be set at a value of the order of ten seconds. In fact, it is not necessary to keep a long history of the frame body of the hashed frames in the aforementioned memory because the attack must be performed “live” by the attacker, who cannot afford to slow down significantly the relaying of frames.

In the test 44, the new HASH_FRAMEBODY sgn-i is compared with those present in the memory, preferably sequentially. If there is in the memory a HASH_FRAMEBODY sgn-j equal to the current HASH_FRAMEBODY sgn-i (the suffixes i and j being different), which corresponds to the arrow y at the output from the test 44, then a man-in-the-middle alarm is raised in the step 45. If not (arrow n at the output from the test 44), the process continues by analyzing a next frame FRA-i (step 46) and the process is repeated for that new frame from the step 40.

The above flowchart gives the optimum process in terms of speed of processing IEEE 802.11 information received by the probe.

It is possible to limit false positives with the more sophisticated embodiment shown in FIG. 4B. In this embodiment, after the test 44 from FIG. 4A, the number K of times that the new HASH_FRAMEBODY is equal to those present in the memory is counted by performing the comparison 44 sequentially (step 47). As soon as this counter exceeds a predefined threshold K_{TH} (arrow y at the output from the test 48), then a man-in-the-middle alarm can be raised (step 45 in FIG. 4A). The value of the threshold K_{TH} can be a parameter of the probe in the sense of the invention. In more general terms, remember that triggering of the step b) of the general process defined above is conditional on detecting a number of packets with exactly the same body in the step a), that number (corresponding in practice to the threshold K_{TH}+1) preferably being chosen for a given configuration of the network. In the particular example of FIG. 4A, this threshold K_{TH} simply has a value of 1.

The FIG. 4B flowchart shows the optimum process in terms of reduction of false positives in the processing of IEEE 802.11 information received by the probe. The tool can implement both methods and dynamically select the more suitable one as a function of the context. It is of course possible to set the parameters of the listening time window to optimize the detection process. Thus, in more general terms, the alarm is triggered in the step b) if first and second packets with the same body are detected in the step a) in a time interval shorter than a predetermined duration, that duration preferably being chosen as a function of a configuration of the network.

In fact, depending on the environment (for example in the repetitive mode of the 802.11 standard), it may be possible for normal retransmission to cause false positives. However, this behavior is rare in principle, and in itself cannot imply serious problems because a man-in-the-middle attack would lead to a large number of alerts, in contrast to sporadic retransmissions in the time window, which can be regarded as short because it must be remembered that the attacker is constrained to be able to retransmit the packet quickly.

The alarm raised by the probe can indicate the previously referred to @MAC_source, @MAC_destination, @MAC_BSSID, TO_DS/FROM_DS and HASH_FRAMEBODY associated with the current frame, and with a frame previously stored in memory. It is then possible to give additional information such as the source, destination and BSSID MAC addresses. Even if, in principle, they are not necessary for attack detection, they can nevertheless assist the operator to track the event more precisely.

A third embodiment is described below in a specific context corresponding to communication between Wi-Fi clients.

In a number of hot-spot and corporate wireless access networks, a function activated at legitimate access points prohibits connections between clients of the same access point. This is referred to bridge-mode operation of the access point. A concrete example of this is the PSPF (Publicly Secure Packet Forwarding) function offered by access points from CISCO (registered trade mark). The invention proves particularly effective if this function is activated.

In contrast, in the absence of this kind of function, a packet sent by a client to another client of the same access point is retransmitted by the legitimate access point without modification of the frame body. The invention would detect this phenomenon as a possible MITM attack. It is therefore possible to add a additional verification step to be applied to packets identified under these conditions. This additional verification step can be activated by the wireless network administrator, for example, depending on the configuration chosen for the network.

It is described as follows. When a client A sends a frame to another client B of the same access point, the TO DS flag of that frame described above is set to 1 and the FROM DS flag is set to 0. The @MAC_destination and @MAC_source fields are respectively filled with the MAC address of B and the MAC address of A and the BSSID field gives the MAC address of the access point.

Then, when this packet is retransmitted by the access point to the client B, the TO DS field is set to 0 and the FROM DS field is set to 1. The @MAC_destination and @MAC_source fields are respectively filled with the MAC address of B and the MAC address of A and the BSSID field gives the MAC address of the access point.

It is therefore sufficient to verify that the two packets identified as having the same frame body have the same @MAC_destination, @MAC_source, and BSSID, and in particular TO DS and FROM DS flags with opposite values, which enables an alarm to be raised with virtually no risk of false positives.

In more general terms, remember that if the intrusion further includes a step of modifying data in the header field (such as the values of the TO DS/FROM DS flags):
in the step a), the header fields of the first and second packets are also compared;
in the step b), the alarm is triggered if the packet bodies are identical and the header fields are different.

Thus the invention is advantageously adapted to a context that does not depend on a “no calls between clients via an access point” type constraint. To this end it is sufficient to add a test on the values of the TO DS/FROM DS flags at the exit from the test 44 on HASH_FRAMEBODY represented in FIG. 4A.

Once deployed, a probe implementing the method finds itself in the situation represented in FIG. 5. The probe S listens to both channels 1 and 2 connecting firstly the attacker ATT to the client CL, and secondly the attacker ATT to the access point AP. It stores in the memory MEM and reads packets in transit on these two paths and detects in particular those that have the same frame body, triggering an alarm if appropriate.

The present invention is also aimed at a probe S of this kind adapted to detect intrusion into communication of private data between a first entity and a second entity (such as an access point), those entities being in communication via a telecommunications network, the probe including:
(preferably) means for reading at least the bodies of packets transmitted between the first entity and the second entity, for example in the memory MEM;
means for comparing packet bodies to detect a first packet and a second packet having identical packet bodies transmitted at respective different times between the first entity and the second entity; and
means SA for triggering an alarm if the number of packets with identical bodies detected is greater than a threshold K_{TH}.

The present invention is also directed to a computer program that can be downloaded via a telecommunications network and/or adapted to be stored in a memory of a probe of the type described above and/or stored on a memory medium intended to cooperate with a reader of the probe. In particular, the program includes instructions for executing a method of the type described above. The present invention is also directed to a data storage medium containing computer program code instructions for executing the steps of the method of the invention.

The present invention is also directed to a system for implementing a method of detecting intrusion into communication of private data, typically between a plurality of entities in communication via a telecommunications network and a plurality of access points of the network. To this end, it includes a plurality of probes forming an architecture deployed in the network and for monitoring the network, each probe including the means set out above.

One advantage of the invention is that detection in the sense of the invention is entirely passive. It requires no interaction with the equipment constituting the wireless network (access point, clients).

Another advantage of the invention is that the detection in progress cannot be detected by an attacker.

A further advantage of the invention is that detection is independent of whether the MAC addresses are misappropriated or not, because it is the content of the frame body that is considered. Detection is also independent of whether the ESSID network names are misappropriated or not.

Another major advantage is that detection is independent of whether the radio channels are the same or not.

Detection is easy to implement in practice. In particular it tolerates loss of packets by the equipment listening to the radio channel. In fact, this has no impact in terms of false positives. As an MITM attack requires numerous successive packets, it will necessarily be detected.

The method of the invention can be implemented very simply in an intrusion detection tool in IEEE 802.11 wireless networks, equipment capable of listening to the IEEE 802.11 radio channel being commonplace.

1. A method of detecting intrusion into communication of private data between a first entity and second entity communicating via a telecommunications network, said communication being effected by sending successive packets, each packet including at least: a header field including at least a source address of the packet and/or a destination address of the packet for appropriate routing of the packets and a packet body including private data; and wherein said intrusion includes connecting between the first entity and the second entity, misappropriating the address of the first entity and/or the address of the second entity as source address and/or destination address, and rerouting packets in this way to recover in particular the private data, wherein the method comprises the steps of:
a) detecting at least a first packet and a second packet having identical packet bodies and transmitted at respective different times between the first entity and the second entity; and
b) triggering an alarm if the number of packets with identical bodies detected in step a) is greater than a predetermined threshold.

2. A method according to claim 1, wherein the telecommunications network is a wireless network.

3. A method according to claim 2, wherein the wireless network is configured in accordance with the IEEE 802.11 standard.

4. A method according to claim 1, wherein said network is a wireless network connected to an extended network.

5. A method according to claim 1, wherein the second entity is an access point of the network.

6. A method according to claim 1, wherein said network includes a plurality of communications channels and steps a) and b) are carried out on at least two of those channels.

7. A method according to claim 1, wherein step b) is triggered if said first and second packets are detected in step a) in a time interval less than a predetermined period, said period being preferably chosen as a function of a configuration of the network.

8. A method according to claim 1, wherein, during said step a):
a signature of the body at least of a second packet is calculated by applying a hashing function to some or all of the data of the packet body;
said signature is stored in memory; and
said signature is compared to the body signature of at least a first packet previously stored in said memory.

9. A method according to claim 8, wherein said hashing function is applied to a portion of the data of the packet body, said data portion being chosen as a function of the configuration of the network and/or as a function of the pertinence of the data to intrusion detection.

10. A method according to claim 1, wherein said intrusion further includes a step of modifying data in the header field, and wherein:
in step a), the header fields of the first and second packets are further compared; and
in step b), the alarm is triggered if the packet bodies are identical and the header fields are different.

11. A method according to claim 1, wherein the packets are transmitted according to a communications protocol that uses data identifying the packets sent, said data being included in the packet body.

12. A method according to claim 1, wherein the predetermined threshold is chosen according to a given configuration of the network.

13. A probe for detecting intrusion into communication of private data between a first entity and a second entity in communication via a telecommunications network, said communication being effected by sending successive packets, each packet including at least: a header field including at least a source address of the packet and/or a destination address of the packet for appropriate routing of the packets, and a packet body including private data; said intrusion including: connecting between the first entity and the second entity, misappropriating the address of the first entity and/or the address of the second entity as source address and/or destination address, and rerouting packets in this way to recover in particular the private data, wherein the probe comprises:
means for comparing the packet bodies to detect at least a first packet and a second packet having identical packet bodies and transmitted at respective different times between the first entity and the second entity; and
means for triggering an alarm if the number of packets with identical bodies detected by the comparison means is greater than a predetermined threshold.

14. A system for detecting intrusion into communication of private data between a plurality of entities in communication via a telecommunications network said communication being effected by sending successive packets, each packet including: a header field including at least a source address of the packet and/or a destination address of the packet for appropriate routing of the packets, and a packet body including private data; said intrusion including: connecting between a first entity and a second entity, misappropriating the address of the first entity and/or the address of the second entity as source address and/or destination address, and rerouting packets in this way to recover in particular the private data, wherein the system includes a plurality of probes forming a network control architecture, each probe comprising:
means for comparing the packet bodies able to detect at least a first packet and a second packet having identical packet bodies and transmitted at respective different times between the first entity and the second entity; and
means for triggering an alarm if the number of packets with identical bodies detected by the comparison means is greater than a predetermined threshold.

15. A computer program, downloadable via a telecommunications network and/or adapted to be stored in a memory of a probe and/or stored on a memory medium intended to cooperate with a reader of said probe, said probe being adapted to detect intrusion into communication of private data between a first entity and second entity communicating via a telecommunications network, said communication being effected by sending successive packets, each packet including at least: a header field including at least a source address of the packet and/or a destination address of the packet for appropriate routing of the packets, and a packet body including private data; said intrusion including: connecting between the first entity and the second entity, misappropriating the address of the first entity and/or the address of the second entity as source address and/or destination address, and rerouting packets in this way to recover in particular the private data, wherein the program comprises instructions for, when it is executed from a memory of the probe:
a) detecting at least a first packet and a second packet having identical packet bodies and transmitted at respective different times between the first entity and the second entity; and
b) triggering an alarm if the number of packets with identical bodies detected is greater than a predetermined threshold.

16. A data storage medium comprising computer program code instructions of the computer program of claim 15.
